(19) United States
(12) Patent Application Publication
(10) Pub. No.: US 2015/0336783 A1
(43) Pub. Date: Nov. 26, 2015

(54) Wine Savor

(71) Applicant: Mohammad Jalali-Farahani, Huntington Beach, CA (US)

(72) Inventor: Mohammad Jalali-Farahani, Huntington Beach, CA (US)

(21) Appl. No.: 14/588,226

(22) Filed: Mar. 9, 2015

Related U.S. Application Data
(60) Provisional application No. 61/965,489, filed on Jan. 31, 2014.

(51) Int. Cl. B67D 1/00; B67D 1/10

(52) U.S. Cl. CPC B67D 1/0004; B67D 1/10

(57) ABSTRACT

The Wine Savor is a pump that conserves the remaining wine in a bottle just opened to maintain its freshness and prevent the damaging impacts of oxidization on the taste and quality of the wine. The Wine Savor solves the wine oxidation in a bottle by preventing a large amount of contact with oxygen when the bottle is first opened and subsequently poured out. Though the bottle will endure some oxidization, the only direct contact with oxygen when using this device is at the exact moment of un-corking the bottle for the first time. The pump will be inserted into the bottle prior to dispensing any liquid for drink. This liquid dispensing pump is combined with an airtight stopper (7), a rubberized case/cover (9) and a nozzle cap (5) prevents any additional oxygen from leaking into the bottle. The pump then allows for wine to be incrementally dispensed over an extended period of time without the concern of exposure to oxidization.

I have developed a pump that conserves the remaining amount of wine in a bottle that has been opened, but not entirely consumed. This innovative technology allows for the remaining wine to maintain its freshness and prevent the damaging impacts of oxidization on the taste and quality of the wine.

When a bottle of wine is opened it becomes exposed to air (oxygen), and subsequently undergoes a process of oxidization. If the remainder of a bottle of wine is re-corked, this process of oxidization significantly impacts the remaining wine, and results in rapid quality depletion that can affect fundamental qualities of fine wine including aroma and taste. The depletion of such qualities ultimately lead to wine spoilage after a short number of days. This is a serious problem for large numbers of casual wine drinkers who wish to consume only a portion of a bottle at a time, conserving the rest for later use.

The Wine Savor solves this problem by preventing a large amount of contact with oxygen when the bottle is first opened and subsequently poured out. Though the bottle will endure some oxidization, the only direct contact with oxygen when using this device is at the exact moment of uncorking. The pump will be inserted into the bottle prior to dispensing any liquid. The pump is combined with an airtight stopper that prevents any additional oxygen from leaking into the bottle. The pump then allows for wine to be incrementally dispensed over an extended period of time without the concern of exposure to oxidization.

Although other devices have been invented to reduce the impact of wine spoilage via oxidization, the Wine Savor is a far superior device due to its reliability, ease of operation, and significantly lessened initial exposure to oxygen. In other words, while many devices with similar intentions attempt to reverse the impact of oxidization after the bottle of wine has already been opened and undergone significant exposure, this device prevents the bulk of the initial oxygen exposure that occurs when the bottle is opened and a portion of wine is poured out.

While I have shown in the accompanying drawings a preferred embodiment of my invention, the plausibility of changes and modifications that do not depart from the spirit of my invention are acceptable.

### DRAWINGS—FIGURES

FIG. 1—Side view of our wine keeper pump in an empty bottle.

FIG. 2—Side view of pump without the Rubberized Case and Stopper.

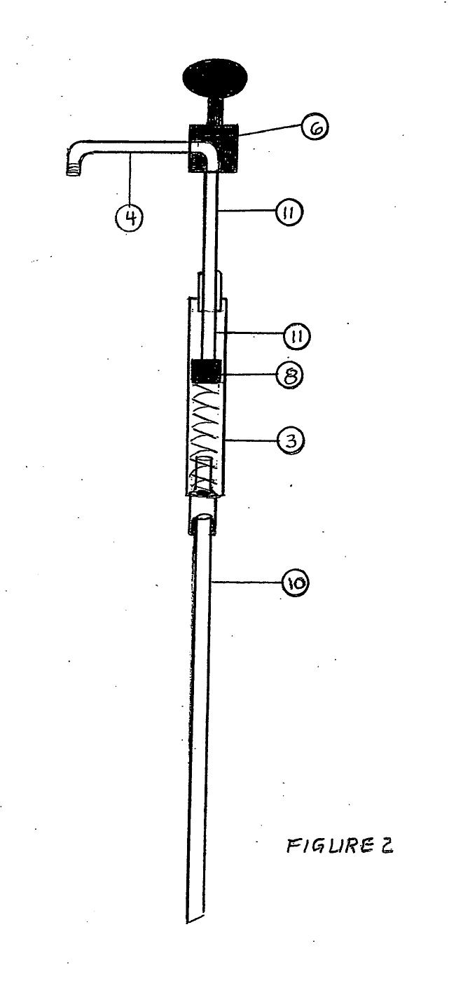

### DRAWINGS—REFERENCE NUMERALS

1—Wine Bottle

2—Pump

3—Pump Cylinder

4—Pump Nozzle/Spout

5—Nozzle Cap

6—Pump Head

7—Stopper glued to Pump

8—Pump Cylinder Piston

9—Rubberized Case/Cover glued to Stopper and Pump Head

10—Tube to suck wine into Pump Cylinder

11—Tube connected to Pump Piston to convey wine into nozzle.

As stated earlier, the Wine Savor this device combines the conservational qualities of airtight caps and sealants, with the functional ability to dispense the wine under those ideal conditions.

The following are some of the details:

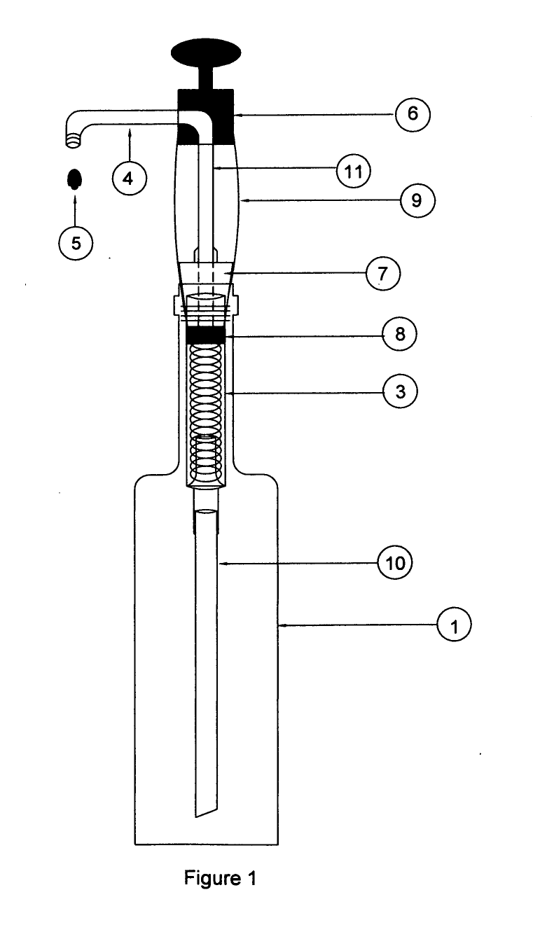

1. The pump consists of a stopper, which is made from a flexible soft rubberized/plastic material that is joined to the external upper portion of the pump cylinder (see FIG. 1). The stopper creates an airtight seal on the mouth of the bottle.

2. There is a durable rubberized sleeve joined from end to the external exposed upper portion of the stopper and joined on the opposite end to the upper portion of the pump (see FIG. 1). It creates an airtight vacuum from the stopper to the upper portion of the pump, and prevents air leakage into the bottle from around the pump cylinder and as a result of the cylinder's piston/rod movements up and down. Due to its flexibility and durability, it allows the piston to move upwards and downwards, pumping the wine out of the bottle.

3. The pump connects to a nozzle/gooseneck spout that pours the wine out of the device and into a wine glass. There is an airtight cap (or a plug in with the shape of a grape) at the mouth of the spout, which can be easily and temporarily removed while pouring the wine out, and replaced once the spout is no longer in use. The cap prevents any air from leaking into the cylinder and/or the bottle.

4. As an option, the nozzle could be removed from the pump head when it is not in used. The nozzle cap would also fit into the pump head and create an airtight. This would allow for the ease of storing the bottle.

The pump is extremely easy to use. As soon as the wine bottle cork is removed, insert the pump into the bottle and push it down until the lower end of the stopper is completely in the neck of the bottle and is airtight. Next, remove the cap from the spout/nozzle mouth, and start pumping the wine out into a glass of wine. When the desired amount of wine is out of the bottle, replace the nozzle cap onto the spout and make sure it is fully attached. The pump operation is very similar to any soap dispenser pump.

The material of the pump is food safe, and will not alter the taste or flavor of the wine as contact is made.

What is claimed is:

1- An innovative liquid dispenser pump that allows for the remaining wine in a bottle just opened to maintain its freshness and prevent the impacts of oxidization on the taste and quality of the wine because the only direct contact of wine in a bottle with oxygen is at the exact moment of un-corking. The pump is comprising:
A stopper made from a flexible soft rubberized/plastic material that is joined to the external upper portion of the pump cylinder. It creates an airtight seal on the mouth of the bottle.
A durable rubberized sleeve joined from end to the external exposed upper portion of the stopper and joined on the opposite end to the upper portion of the pump. It creates an airtight vacuum from the stopper to the upper portion of the pump, and prevents air leakage into the bottle from around the pump cylinder and as a result of the cylinder's piston/rod movements up and down. Due to its flexibility and durability, it allows the piston to move upwards and downwards, pumping the wine out of the bottle.
A nozzle/gooseneck spout connected to the pump and pours the wine out of the device and into a wine glass. There is an airtight cap (or a plug in with the shape of a grape) at the mouth of the spout, which can be easily and temporarily removed while pouring the wine out, and replaced once the spout is no longer in use. The cap prevents any air from leaking into the cylinder and/or the bottle.
The nozzle could be removed from the pump head when it is not in used. The nozzle cap would also fit into the pump head and create an airtight. This would allow for the ease of storing the bottle.
